(19) United States
(12) Patent Application Publication
(10) Pub. No.: US 2004/0182596 A1
(43) Pub. Date: Sep. 23, 2004

(54) Method and apparatus for insulating magnet wire

(76) Inventor: John Michael Sedlak, Shreveport, LA (US)

Correspondence Address: John S. Beulick, Armstrong Teasdale LLP, One Metropolitan Sq., Suite 2600, St. Louis, MO, 63102, US

(21) Appl. No.: 10/389,793

(22) Filed: Mar. 17, 2003

(51) Int. Cl. H01B 7/00; H02K 1/00; H02K 3/40

(52) U.S. Cl. 174/120 R; 310/196; 174/110 SR

(57) ABSTRACT

A magnet wire for an electrical equipment system includes a conductor, an insulation coating at least a portion of the conductor for insulating the conductor, and at least one of a varnish and an epoxy coating at least a portion of the insulation, wherein at least one of the varnish and the epoxy include a corona suppressing material.

### BACKGROUND OF THE INVENTION

This invention relates generally to magnet wire and more particularly to magnet wire insulation.

Some known electrical equipment systems, for example electric motors and generators, use magnet wire grouped into one or more sets of windings. Typically, the magnet wire windings include organic insulating materials thereon, for example wire enamel. The insulating materials of the magnet wire are sometimes susceptible to corona damage. Corona is a luminous discharge that surrounds high voltage conductors and is caused by ionization of surrounding air. Corona appears when electrical fields generated by high voltage conductors are sufficiently high to break down and/or ionize air. Corona may cause oxidation of organic materials, thereby resulting in discoloration and dusting of such organic materials. Particularly, corona may wear away magnet wire insulation enamel thereby facilitating failure of magnet wire insulation. In some known electrical equipment systems, corona-suppressing material, for example aluminum oxide, is added to the wire enamel before application to the magnet wire. Once applied to the magnet wire, the corona suppressing material causes ionized particles to discharge on the corona suppressing materials surface thereby protecting the wire enamel.

### BRIEF SUMMARY OF THE INVENTION

In one aspect, a magnet wire for an electrical equipment system is provided. The magnet wire includes a conductor, an insulation coating at least a portion of the conductor for insulating the conductor, and at least one of a varnish and an epoxy coating (also rubber) at least a portion of the insulation, wherein at least one of the varnish and the epoxy include a corona suppressing material.

In another aspect, an electric motor is provided including a housing and a stator having at least one winding and a bore therethrough. The stator is mounted in the housing. The at least one winding includes an insulation coating at least a portion of the at least one winding for insulating the at least one winding, and at least one of a varnish and an epoxy coating at least a portion of the at least one winding. The at least one of a varnish and an epoxy includes a corona suppressing material. The electric motor further includes a rotor shaft extending at least partially through the bore and the housing, and a rotor core mounted on the rotor shaft. The rotor core includes at least one magnet.

In yet another aspect, a method is provided for insulating a magnet wire for an electrical equipment system. The electrical equipment system includes at least one magnet wire, an insulating material, and at least one of a varnish and an epoxy. The method includes coating at least a portion of the magnet wire with the insulating material, mixing a corona suppressing material into the at least one of a varnish and an epoxy, and coating at least a portion of the insulating material with the at least one of an epoxy and a varnish.

### BRIEF DESCRIPTION OF THE DRAWINGS

FIG. 1 is a side view of one embodiment of an electrical equipment system of the present invention.

FIG. 2 is a perspective view of an exemplary embodiment of a winding of the present invention.

FIG. 3 is a perspective view of an exemplary embodiment of a winding of the present invention.

FIG. 4 is a flow chart illustrating one embodiment of a method for insulating a magnet wire for an electrical equipment system.

### DETAILED DESCRIPTION OF THE INVENTION

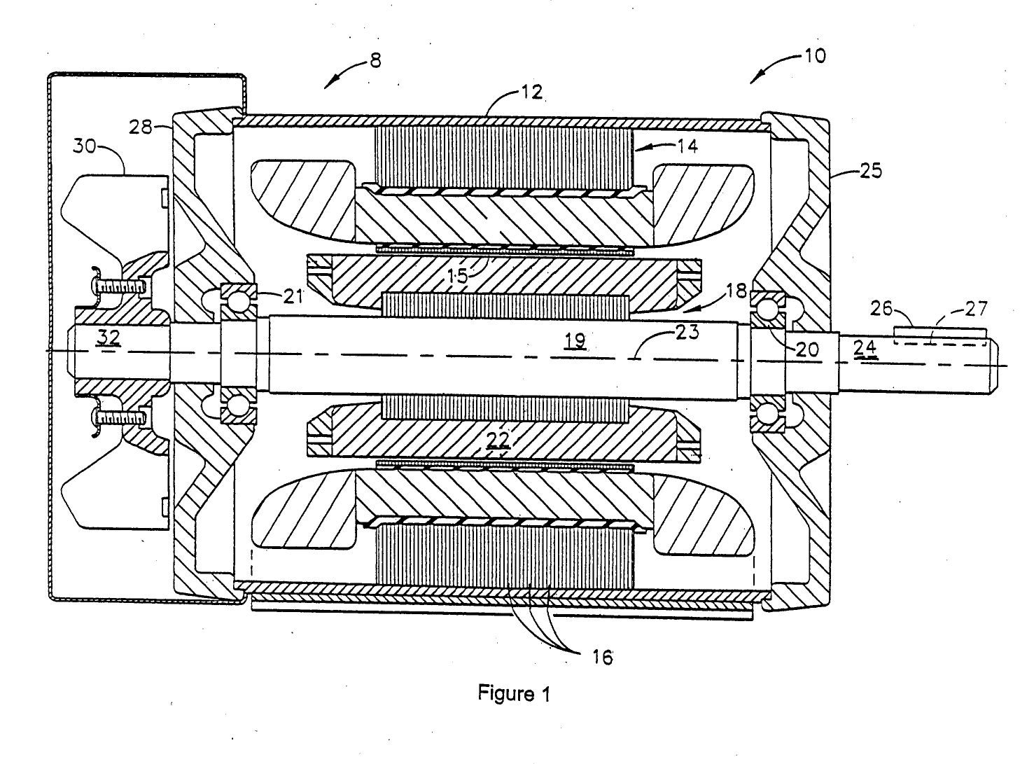

FIG. 1 is a side cross sectional view of one embodiment of an electrical equipment system 8. Although electrical equipment system 8 is hereafter described and illustrated as, and in the context of, an electric motor 10, it will be understood that motor 10 may be, and electrical equipment system 8 may include, any of electrical equipment operating at least partially on voltage. For example, in one embodiment, electrical equipment system 8 is an electric generator. Furthermore, and in one embodiment, electrical equipment system 8 includes an electric generator. In another exemplary embodiment, electrical equipment system 8 includes at least one of an oil filled transformer and a dry-type transformer. Accordingly, the foregoing apparatus and methods are applicable to any piece of electrical equipment that operates at least partially on voltage. In addition, and for example, in one embodiment motor 10 is a #29 frame motor commercially available from the General Electric Company, Louisville, Ky. In one embodiment, electrical equipment system 8 operates at a voltage greater than or equal to 500 volts. In another embodiment, electrical equipment system 8 operates at a voltage less than or equal to 500 volts.

Motor 10 includes a substantially cylindrical outer casing 12, and a generally cylindrical stator 14 that is positioned substantially coaxially within outer casing 12, and includes a coaxial stator bore 15 that extends therethrough. In the exemplary embodiment, stator 14 includes a plurality of windings 16 each representing a respective motor phase. A rotor core 18 is mechanically coupled to a shaft 19 that is supported by a front bearing 20 and a back bearing 21 which are each coupled to casing 12. In one embodiment, rotor core 18 includes at least one magnet 22. In another embodiment, rotor core 18 includes a plurality of windings 22. Rotor core 18 extends axially through stator bore 15 for rotational movement about a stator bore axis 23. In an exemplary embodiment, a rotor shaft extension 24 extends axially from a front end shield 25 of motor 10, and includes a key 26 that projects radially outward from a keyway 27 that is cut axially a distance from shaft extension 24. Key 26 locks shaft extension 24 into a corresponding key way cut in a load member (not shown) e.g. a fan, to which rotational motive power is to be supplied by motor 10.

A back end shield 28 together with casing 12 and front end shield 25 contains and protects stator 14, rotor core 18 and associated conductive windings. In the example shown, a motor cooling fan 30 is mounted on a rotor stub portion 32 that extends outwardly from back end shield 28, and directs an air current flow over casing 12.

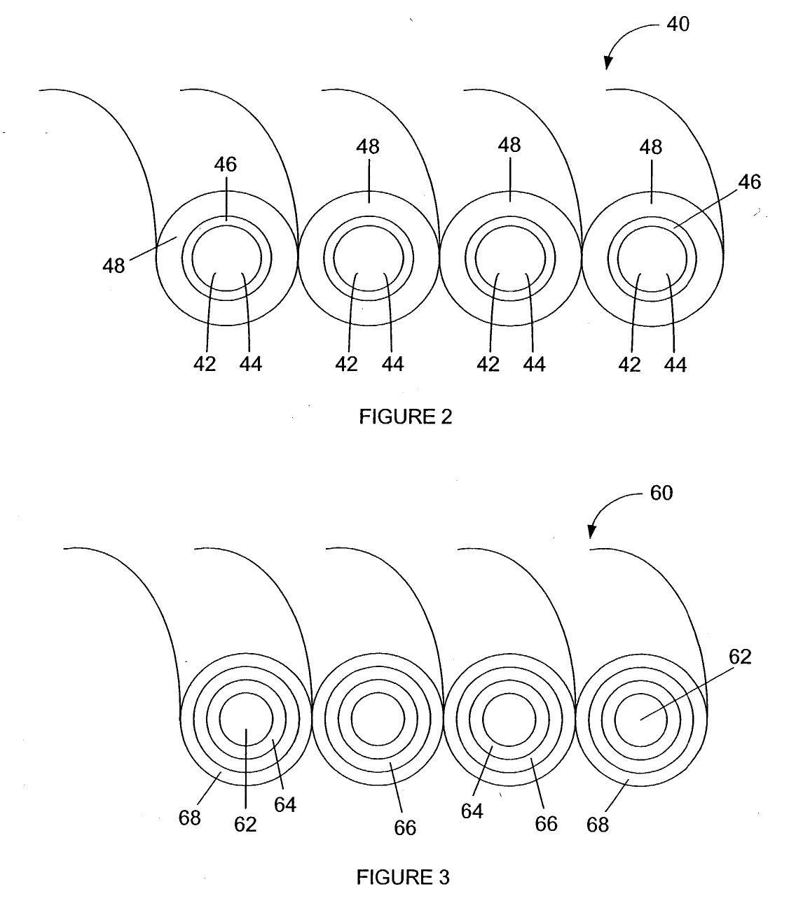

FIG. 2 is an end view of a portion of a winding 40 that can be used with electrical equipment system 10 shown (shown in FIG. 1). Winding 40 includes a magnet wire 42, such as a metallic conductor wire, wound into a coil on stator 14 (shown in FIG. 1) and as used herein, magnet wire describes a solid conductor wire insulated with at least one coating. The coating facilitates providing a uniform dielectric coating while taking up as little space as possible. Illustrated within FIG. 2 is a single conductor section 44 of magnet wire 42 that forms winding 40. It will be understood that a plurality of conductor sections 44 are portions of one continuous electrical conductor wound around the stator. In one embodiment, magnet wire 42 is a copper wire. In an alternative embodiment, winding 40 at least partially includes a plurality of conductor bars (not shown) fabricated from a material such as, but not limited to, a copper material and an aluminum material. Winding 40 includes an insulating material 46 coating at least a portion of conductor sections 44 and thus magnet wire 42. In the exemplary embodiment, insulating material 46 is an enamel. In another embodiment, insulating material 46 is fabricated from a material, such as, but not limited to, a paper material, a cotton material, a fiberboard material, and a rubber. In use, insulating material 46 isolates conductor sections 44 from each other and isolates winding 40 from metal surfaces within the motor as well as dirt and water.

Winding 40 further includes a material 48 coating at least a portion of insulating material 46. Material 48 includes at least one of an epoxy and a varnish, hereinafter referred to as epoxy/varnish 48. In use, epoxy/varnish 48 facilitates preventing a movement of conductor sections 44 and thus magnet wire 42 during operation of motor 10. Epoxy/varnish 48 includes a corona suppressing material (not shown) blended within epoxy/varnish 48 before epoxy/varnish 48 is applied to, or coated over, at least a portion of insulating material 46. The corona suppressing material discharges ionized particles from a surface of the corona suppressing material during operation of motor 10. More specifically, the corona suppressing material protects against the oxidation of the organic materials of insulating material 46, thereby protecting insulating material 46 from discoloration, dusting, and wear. The corona suppressing material remains in place and effective to protect insulating material 46 after epoxy/varnish 48 has cured and/or partially evaporated after application to insulating material 46. In one embodiment, the corona suppressing material is an aluminum oxide that is added to varnish 48 in the form of at least one of a slurry, a suspension, a screened coating, and a spray. In the exemplary embodiment, varnish 48 including the corona suppressing material is applied to winding 40 after winding 40 has been installed into electrical equipment system 8. For example, the winding is installed in a motor, a transformer other electrical equipment, and then the corona suppressing material is applied. In another embodiment, the corona suppressing material is applied to electrical equipment system 8 prior to being installed.

FIG. 3 is an end view of a portion of a winding 60 that can be used with electrical equipment system 10 shown (shown in FIG. 1). Winding 60 includes a magnet wire 62 and an insulating material 64 coating at least a portion of magnet wire 62. In the exemplary embodiment, insulating material 64 is an enamel. In another embodiment, insulating material 64 is fabricated from a material, such as, but not limited to, a paper material, a cotton material, and a fiberboard material. Winding 60 also includes a second coating of enamel 66 covering at least a portion of insulating material 64. In one embodiment, enamel 66 includes, but is not limited to, a polyester and does not include a corona suppressing material.

Winding 60 further includes a material 68 coating at least a portion of enamel 66. Material 68 includes at least one of an epoxy, a varnish, and a paint, hereinafter referred to as varnish 68. Varnish 68 includes a corona suppressing material (not shown) blended within varnish 48 before varnish 48 is applied to, or coated over, at least a portion of insulating material 46. In the exemplary embodiment, the corona suppressing material is an aluminum oxide.

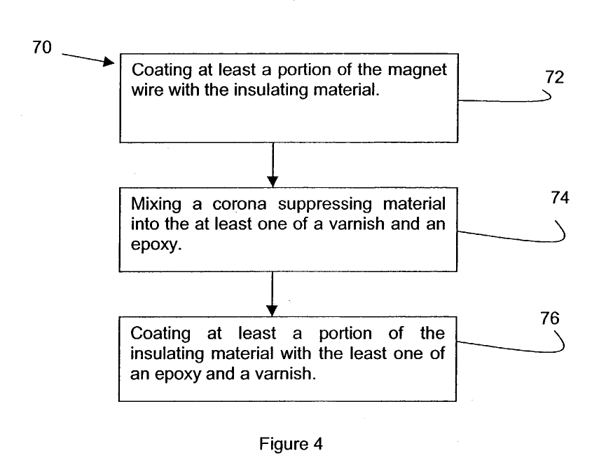

FIG. 4 is a flowchart illustrating a method 70 for insulating magnet wire. Method 70 includes coating 72 at least a portion of the magnet wire with an insulating material, mixing 74 a corona suppressing material into at least one of a varnish, an epoxy, and a paint, and coating 76 at least a portion of the insulating material with the least one of an epoxy and a varnish.

By incorporating a corona suppressing material into an epoxy/varnish, an insulating material is protected from discoloration, dusting, and wear. Furthermore, the cost of magnet wire is lowered because standard grades of wire can be used rather than wire having insulating materials capable of corona suppression. Additionally, the outermost coating protects and reduces damage to both mineral oil and food grade or other vegetable based dielectric oils caused by degradation of the protective coatings from corona discharge off the conductors into the surrounding dielectric oil coolant.

While the invention has been described in terms of various specific embodiments, those skilled in the art will recognize that the invention can be practiced with modification within the spirit and scope of the claims.

What is claimed is:

1. A magnet wire for an electrical equipment system, said magnet wire comprising:
a conductor;
an insulation coating surrounding at least a portion of said conductor for insulating said conductor; and
an outermost coating surrounding at least a portion of said insulation coating, said outermost coating comprising at least one of a varnish and an epoxy having a corona suppressing material.

2. A magnet wire in accordance with claim 1 wherein said electrical equipment system includes at least one of an electrical motor including at least one winding, said at least one winding including said magnet wire and an electrical generator including at least one winding, said at least one winding including said magnet wire.

3. A magnet wire in accordance with claim 1 wherein at least a portion of the electrical equipment system operates at approximately 500 volts.

4. A magnet wire in accordance with claim 1 wherein said at least one of a varnish and an epoxy inhibiting said magnet wire during operation of the electrical equipment system.

5. A magnet wire in accordance with claim 1 wherein said conductor comprises at least one of a copper wire, and an aluminum wire.

6. A magnet wire in accordance with claim 1 wherein said insulation comprises enamel.

7. A magnet wire in accordance with claim 1 wherein said corona suppressing material comprises aluminum oxide.

8. An electric motor comprising:
a housing;
a stator comprising at least one winding and a bore therethrough, said stator mounted in said housing, said at least one winding comprising an insulation coating at least a portion of said at least one winding for insulating said at least one winding; at least one of a varnish and an epoxy coating at least a portion of said at least one winding, said at least one of a varnish and an epoxy comprising a corona suppressing material;
a rotor shaft extending at least partially through said bore and said housing; and
a rotor core mounted on said rotor shaft, said rotor core comprising at least one magnet.

9. An electric motor in accordance with claim 8 wherein said at least one winding includes at least one magnet wire, said at least one of a varnish and an epoxy inhibiting movement said at least one magnet wire during operation of said electric motor.

10. An electric motor in accordance with claim 8 wherein said corona suppressing material discharges ionized particles from a surface of said corona suppressing material during operation of said electric motor.

11. An electric motor in accordance with claim 9 wherein said magnet wire comprises a copper wire.

12. An electric motor in accordance with claim 8 wherein said insulation comprises enamel.

13. An electric motor in accordance with claim 10 wherein said corona suppressing material comprises aluminum oxide.

14. An electric motor in accordance with claim 8 wherein said rotor core comprises at least one winding, said at least one winding comprising an insulation coating at least a portion of said at least one winding; at least one of a varnish and an epoxy coating at least a portion of said at least one winding and comprising a corona suppressing material.

15. A method for insulating a magnet wire for an electrical equipment system including at least one magnet wire, an insulating material, and at least one of a varnish and an epoxy, said method comprising:
coating at least a portion of the magnet wire with the insulating material;
mixing a corona suppressing material into the at least one of a varnish an epoxy, and a paint; and
coating at least a portion of the insulating material with at least one of epoxy, the varnish, and the paint.

16. A method in accordance with claim 15 wherein the corona suppressing material is aluminum oxide, further inhibiting movement of the magnet wire during operation of the electrical equipment system using the at least one of a varnish and an epoxy.

17. A method in accordance with claim 15 further comprising discharging ionized particles from a surface of the corona suppressing material during operation of the electrical equipment system using the corona suppressing material.

18. A method in accordance with claim 15 wherein the magnet wire is a copper wire, said coating at least a portion of the magnet wire with the insulating material comprising coating at least a portion of the copper wire with the insulating material.

19. An electrical transformer comprising:
a conductor;
an insulation coating surrounding at least a portion of said conductor for insulating said conductor; and
an outermost coating surrounding at least a portion of said insulation coating, said outermost coating comprising at least one of a varnish and an epoxy having a corona suppressing material.

20. A transformer in accordance with claim 19 wherein said conductor comprises at least one of a copper wire, and an aluminum wire.

21. A transformer in accordance with claim 19 wherein said outermost coating facilitates reducing degradation of a dielectric oil coolant from corona discharge off said conductor into said surrounding dielectric oil coolant.
